(19) United States
(12) Patent Application Publication
(10) Pub. No.: US 2019/0371485 A1
(43) Pub. Date: Dec. 5, 2019

(54) NONLINEAR COMPOSITE COMPOSITIONS, METHODS OF MAKING THE SAME, AND ARTICLES INCLUDING THE SAME

(71) Applicant: 3M INNOVATIVE PROPERTIES COMPANY, St. Paul, MN (US)

(72) Inventors: Mahmut Aksit, Woodbury, MN (US); Dipankar Ghosh, Oakdale, MN (US)

(21) Appl. No.: 16/465,401

(22) PCT Filed: Nov. 27, 2017
(86) PCT No.: PCT/US2017/063269

§ 371 Date: May 30, 2019

Related U.S. Application Data
(60) Provisional application No. 62/429,293, filed on Dec. 2, 2016.

(51) Int. Cl. H01B 1/20; H02G 15/064; H02G 15/103; H02G 1/14; C08K 3/22; C08K 7/00; C09D 183/04; C09D 179/08; C09D 7/40; C09D 7/61

(52) U.S. Cl. CPC H01B 1/20; H02G 15/064; H02G 15/103; H02G 1/14; C08K 3/22; C08K 2201/016; C09D 183/04; C09D 179/08; C09D 7/70; C09D 7/61; C08K 2003/2289; C08K 7/00

(57) ABSTRACT

Nonlinear composite compositions comprise a dielectric matrix material and flakes of a mixed metal oxide having the formula M1ₓM2_{y}O_{z} dispersed in the dielectric matrix material. M1 is selected from the group consisting of alkali metals, alkaline earth metals, and combinations thereof. M2 is a transition metal or post-transition metal, wherein M2 has an atomic number no greater than 78. The number x is in the range 0.3≤x≤1, y is a number in the range 0.5≤y≤1.5, and z is a number selected such that the mixed metal oxide is electrically neutral, wherein the amount of flakes in the nonlinear composite composition is sufficient that the nonlinear composite composition has a nonlinear increasing conductivity in response to increasing electric field. Methods of making nonlinear composite compositions and articles including them are disclosed.

### TECHNICAL FIELD

The present disclosure broadly relates to nonlinear composite compositions, methods of making them, and articles including them.

### BACKGROUND

Electric field grading, or electrical stress control, refers to the technique of reducing local enhancements of the electric field in various devices, especially electrical power cable accessories. As a part of insulation coordination, electrical field grading is especially important as voltage levels are increasing and sizes of components are shrinking. Criteria such as cost, safety issues and low electric fields, and temperatures are often contradictory. For example, thinner insulation leads to lower material costs and lower temperatures but to higher electric fields, which can lead to electric breakdown and failure, particularly at critical regions such as interfaces or triple points. Appropriate field grading can help attain or improve and optimize a design that appropriately balances such criteria.

Field grading methods generally fall into two main classes: a) capacitive field grading (e.g., geometrical electrode grading with appropriate shape of conductive parts, refractive grading with high-permittivity materials, and condenser grading with integration of metallic elements); and b) resistive field grading, using special materials with appropriate current-field characteristics. This simple classification is based on whether the displacement (i.e., capacitive current, or resistive current) dominates the field grading mechanism.

Resistive field grading materials generally display a nonlinear conductivity, meaning that the normally insulating material becomes more conductive at elevated levels of electric field values. Usually, capacitive field grading materials have relatively high dielectric constant and low dielectric loss. Both kinds of materials are able to avoid failure at the critical region by redistributing the electrical field at extreme conditions.

U.S. Pat. No. 8,974,706 (Somasiri et al.) describes electrical stress control technology using conductive carbon black and high dielectric constant ceramic barium titanate/polymer composites.

The electrical conductivity of such composites depends on percolation properties of the conductive filler particles (e.g., the resistivity of such materials is very sensitive on small fluctuations of parameters that influence particle dispersion), and thus processing and manufacturing parameters need to be carefully controlled for making such composites.

U.S. Pat. No. 6,124,549 (Kemp et al.) discloses another approach based on using varistor powder (e.g., doped ZnO) and filler particles materials disposed in a polymeric matrix. Relatively high particle loading levels in systems of this type are generally required to see nonlinear properties of the composites.

### SUMMARY

The present disclosure describes another approach for stress control using nonlinear composite compositions based on flake fillers of sodium cobalt oxides (i.e., NaₓCoO₂ (0.6<x<0.75)), calcium cobalt oxide (Ca₃Co₄O₉), and/or delafossite group minerals dispersed in a polymer matrix. These nonlinear composite compositions show reproducible nonlinear electrical conductivity with respect to electric field. The metal oxide materials are manufactured in the form of anisotropic flakes with nanometer scale thicknesses resulting in higher average cross-section area within the polymer matrix in parallel to applied electric field (E-field). Because of the high aspect ratio and generally two-dimensional-like nature of the filler materials, this technology enables us to make composite nonlinear resistors (varistors) with lower loading levels (15-30 wt. % as opposed to >50 wt. % with typical ceramic varistors) which can potentially be of help with respect to mechanical properties of the nonlinear composite compositions, ease of manufacturing, and lower cost.

In one aspect, the present disclosure provides a nonlinear composite composition comprising:
a dielectric matrix material; and
flakes of a mixed metal oxide having the formula M1ₓM2_{y}O_{z} dispersed in the dielectric matrix material, wherein:
M1 is selected from the group consisting of alkali metals, alkaline earth metals, and combinations thereof;
M2 is a transition metal or post-transition metal, wherein M2 has an atomic number no greater than 78; and
x is a number in the range 0.3≤x≤1;
y is a number in the range 0.5≤y≤1.5; and
z is a number selected such that the mixed metal oxide is electrically neutral, wherein the amount of flakes in the nonlinear composite composition is sufficient that the nonlinear composite composition has a nonlinear increasing conductance in response to increasing electric field.

In some embodiments, the nonlinear composite composition is curable, while in other embodiments, it is not curable.

In another aspect, the present disclosure provides a method comprising applying a curable nonlinear composite composition according to the present disclosure to a surface of a substrate, and at least partially curing the curable nonlinear composite composition.

In another aspect, the present disclosure provides a method comprising applying a nonlinear composite composition dispersed and/or dissolved in a solvent to a surface of a substrate, and at least partially removing the solvent.

In yet another aspect, the present disclosure provides an article comprising a nonlinear composite composition disposed on a surface of a conductive substrate, wherein the nonlinear composite composition comprises:
a dielectric matrix material; and
flakes of a mixed metal oxide having the formula M1ₓM2_{y}O_{z} dispersed in the dielectric matrix material, wherein:
M1 is selected from the group consisting of alkali metals, alkaline earth metals, and combinations thereof;
M2 is a transition metal or post-transition metal, wherein M2 has an atomic number no greater than 78; and
x is a number in the range 0.3≤x≤1;
y is a number in the range 0.5≤y≤1.5; and
z is a number selected such that the mixed metal oxide is electrically neutral, wherein the amount of flakes in the nonlinear composite composition is sufficient that the nonlinear composite composition has a nonlinear increasing conductance in response to increasing electric field.

Exemplary such articles include electrical stress control composites for cable terminations, cable splices, gas insulated switches, and surge arrestors.

As used herein:

“flake” in reference to filler shapes refers to thin particles, which may be flat or curved, that have a particle thickness that is substantially less that the particle length and particle width; for example, flakes may have an aspect ratio (length/thickness) of at least 10, at least 50, or even at least 100;

“percolation threshold” means the critical fraction of lattice points that must be filled to first create an infinitely continuous conductive path;

“nonlinear composite composition” means a composition having an electrical resistivity that varies with applied voltage such that it has a nonlinear, non-ohmic current/voltage characteristic for two directions of traversing current. At low voltage the nonlinear composite composition has a high electrical resistivity which decreases as the voltage is raised.

Features and advantages of the present disclosure will be further understood upon consideration of the detailed description as well as the appended claims.

### BRIEF DESCRIPTION OF THE DRAWINGS

FIG. 1 is a schematic side view of a composite article 100 including a nonlinear composite composition according to the present disclosure.

FIGS. 2A and 2B are SEM micrographs of Ca₃Co₄O₉ flakes prepared in the Examples.

FIG. 3 is a plot of current versus applied voltage for the nonlinear composite composition specimen produced in Example 1.

FIG. 4 is a plot of current versus applied voltage for the nonlinear composite composition specimen produced in Example 2.

FIG. 5 is a plot of current versus applied voltage for the nonlinear composite composition specimen produced in Example 3.

FIG. 6 is a plot of current versus applied voltage for the nonlinear composite composition specimen produced in Example 4.

FIG. 7 is a plot of current versus applied voltage for the nonlinear composite composition specimen produced in Example 5.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Nonlinear composite compositions according to the present disclosure include a dielectric matrix material and flakes of a mixed metal oxide having the formula M1ₓM2_{y}O_{z} as discussed herein above.

The dielectric matrix material forms a typically continuous phase in which the flakes of mixed metal oxide are dispersed.

The dielectric matrix material into which the flakes of a mixed metal oxide are dispersed can comprise any suitable organic polymeric material or ceramic material, and optionally one or more additional organic or inorganic components. Suitable dielectric matrix materials are essentially electrically nonconductive (i.e., electrically insulating) materials. Useful dielectric matrix materials may include any dielectric materials useful in the electronic arts. Suitable dielectric materials include dielectric polymeric materials such as thermoplastic polymers and uncured or at least partially cured polymeric resins, and combinations thereof.

In some embodiments, the dielectric matrix material may comprise ceramic materials such as, for example alumina, zirconia, silica, and combinations thereof.

In some embodiments, the dielectric matrix material may comprise a thermoplastic composition, which may be raised to a sufficiently high temperature that the flakes of a mixed metal oxide can be adequately compounded into it, and then cooled to form a solidified article. Examples of suitable thermoplastic compositions include filled or unfilled, polyurethanes, thermoplastic silicone vulanisates, EVA (ethylene-vinyl acetate) based polymers, EPDM (ethylene-propylene-diene rubber), olefinic polymers (e.g., polyethylene or polypropylene), polyesters, polycarbonates, and combinations thereof.

In some embodiments, the dielectric matrix material may comprise an organic thermoset material into which the flakes of mixed metal oxide can be dispersed, and which can then be cured by any suitable means (e.g., thermal energy, actinic radiation, addition of catalysts and/or initiators) to form a solid article. Examples of suitable curable polymeric resins that may be cured include urethane resins; silicone resins; epoxy resins; isocyanate resins, cyanate resins; phenolic resins; and combinations thereof. Preferably, the dielectric matrix comprises a cured silicone polymer.

A mixed metal oxide having the formula M1ₓM2_{y}O_{z} is dispersed in the dielectric matrix material. A majority of the mixed metal oxide (e.g., at least 50 weight percent, at least 60 weight percent, at least 70 weight percent, at least 80 weight percent, at least 90 weight percent, at least 99 weight percent, or even all) is in the form of flakes. The flakes are preferably substantially flat but may have curvature as long as the thickness remains substantially thinner than the length and width of the flake. For example, the average aspect ratio (i.e., the ratio of length to thickness) of the flakes may be at least 5, at least 10, at least 20, or even at least 50. Likewise, the ratio of the flake width to thickness may be at least 5, at least 10, at least 20, or even at least 50. The two-dimensional nature of the flakes, when aligned, may cause the nonlinear electrical conductivity (or current (I) for fixed geometries) of the nonlinear composite composition to be anisotropic under an applied electric field (voltage drop (V) for fixed geometries). For example good conductivity may be observed in X and Y directions, but not in the Z direction.

The mixed metal oxide has the formula M1ₓM2_{y}O_{z}, wherein x is a number in the range 0.3≤x≤1, y is a number in the range 0.5≤y≤1.5, and z is a number selected such that the mixed metal oxide is electrically neutral (i.e., not charged). In some preferred embodiments, the ratio of z/y is about 2.25. In some particularly preferred embodiments, the mixed metal oxide has the empirical formula Na_{0.72}CoO₂ or Ca₃Co₄O₉.

M1 is selected from the group consisting of alkali metals (e.g., Li, Na, K, Cs), alkaline earth metals (e.g., Be, Mg, Ca, Ba, Sr), and combinations thereof. In some preferred embodiments, M1 is an alkali metal or a combination thereof. In some preferred embodiments, M1 is a mixture of alkali metal and alkaline earth metal. M2 is a transition metal or post-transition metal, wherein M2 has an atomic number no greater than 78. Examples include Al, Sc, Ti, V, Cr, Mn, Fe, Co, Ni, Cu, Zn, Ga, Ge, Y, Zr, Nb, Mo, (Tc), Ru, Rh, Pd, Ag, Cd, In, Sn, Sb, Lu, Hf, Ta, W, Re, Os, Ir, and Pt. Of these, Co is preferred in some embodiments.

Mixed metals oxides according to the above formula may be obtained from commercial sources or made according to known procedures. For example, U.S. Pat. Appln. Publ. No. 2014/0093778 A1 (Aksit et al.) describes suitable methods for making single crystal mixed metal oxide nanosheet material compositions.

The amount of mixed metal oxide in the composition may be any value that imparts a nonlinear increasing conductance in response to increasing electric field. The amount may be affected by the flake size and/or flake orientation. Preferably, the flakes are oriented substantially parallel to each other, although this is not a requirement. For example, a majority of the mixed metal oxide flakes (e.g., at least 50 weight percent, at least 60 weight percent, at least 70 weight percent, at least 80 weight percent, at least 90 weight percent, at least 99 weight percent, or even all) may be aligned substantially parallel (e.g., within 15 degrees, 10 degrees, or even 5 degrees) to one another.

Preferably, the amount of the mixed metal oxide present as flakes is from 5 to 50 weight percent, more preferably 10 to 40 weight percent, and even more preferably 15 to 30 weight percent, based on the total weight of the nonlinear composite composition.

The resulting nonlinear composite composition might be stiff and rigid, or might be relatively elastomeric. However, it is not strictly necessary that the resulting composition be solid. Rather, it might be a semi-solid, grease, gel, wax, mastic, or even an adhesive (e.g., a pressure-sensitive adhesive), if desired.

Nonlinear composite compositions according to the present disclosure may also comprise any other suitable additive(s), for example to improve processability, weatherability, and so on. Potentially useful additives may include, for example, dispersing agents, processing aids, mold release agents, stabilizers, conductive or nonconductive fillers, antioxidants, colorants, and plasticizers. In certain embodiments, the conductive filler may be a graphene-based material (e.g., graphene, doped graphene, functionalized graphene, exfoliated graphite, graphene nanoplatelets, or graphite nanoplatelets). In some embodiments, a conductive filler may be present in the form of carbon black. However, in other embodiments, the nonlinear composite composition is substantially free of carbon black. In some embodiments, the nonlinear composite composition is substantially free of any type of conductive material. In some embodiments, one or more additional conductive materials may be present in the nonlinear composite composition. Any suitable particulate conductive material may be used. In some embodiments, the conductive filler particles may comprise an aspect ratio of at least about 5, 10, 100, or higher.

In some embodiments, one or more additional nonconductive (insulating) materials such, for example, as barium titanate, titanium oxide, barium strontium titanate, strontium titanate may also be present.

In some embodiments, one or more additional conductive materials may be present in the nonlinear composite composition. Any suitable particulate conductive material may be used. In some embodiments, the conductive filler particles may comprise an aspect ratio of at least about 5, 10, 100, or higher.

The particle size of any such additive that is active in performing electric field grading may be chosen as desired. In various embodiments, such an additive may comprise an average particle size of no more than about 200, 100, 40, or 20 microns. In further embodiments, such an additive may have an average particle size of at least about 0.1, 1, 2, 4, 8, or 16 microns. If desired, any such additive may comprise any suitable surface treatment or the like that enhances the ability of the particles to be dispersed into a desired polymer matrix. For example, the particles may be treated or coated with hydrophobic groups. In some embodiments, a nonlinear composite composition may include nanoparticles, in the general manner as described in U.S. Patent Appln. Publ. 2011/0 140052 (Somasiri).

The nonlinear composite composition may be dissolved and/or suspended in an organic solvent to facilitate processing (e.g., if the is nonlinear composite composition is not fluid); however, most or all solvent is typically removed before use in a finished electronic article.

Nonlinear composite compositions may be made by simple mixing of the components (e.g., dielectric matrix material or a precursor thereof, mixed metal oxide, and any optional ingredients). If desired, organic solvent may be used to reduce viscosity, although it should typically be subsequently removed after compounding, and optionally coating. If a dielectric matrix material precursor (e.g., a curable organic resin) is included, then a curing step or steps may be included before and/or after removal of the solvent. Examples of suitable solvents include ethers, ketones, esters, and halocarbons.

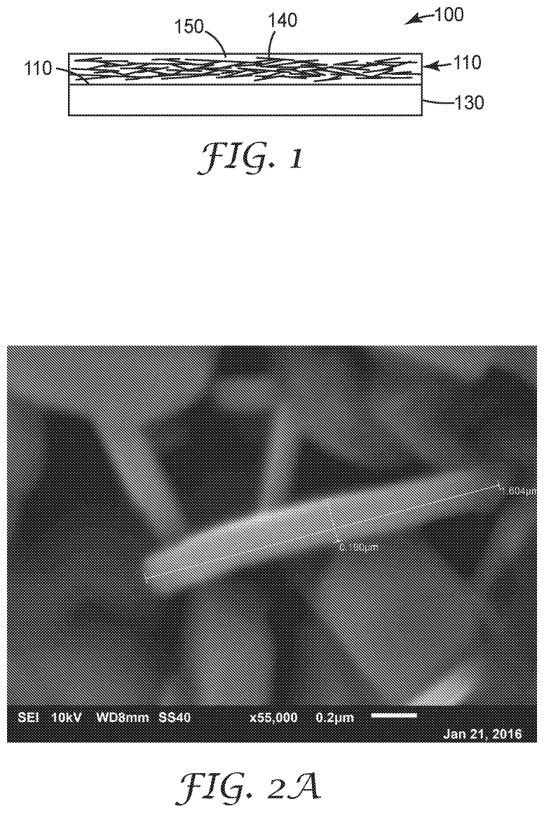

The nonlinear composite composition may be used directly (e.g., as a paste or gel) or it may be coated, by any suitable technique onto a surface of a substrate, resulting in a composite article. Referring now to FIG. 1, composite article 100 comprises nonlinear composite composition 110 disposed on surface 120 of substrate 130. Nonlinear composite composition 110 includes mixed metal oxide flakes 140 dispersed in dielectric matrix material 150.

Any solid substrate may be used; however, nonlinear composite compositions according to the present disclosure are advantageously used on substrate that are conducting and preferably capable of carrying a substantial current load and high voltage. Examples include exposed power cables (e.g., cable splices and cable terminations), and interior surfaces of switch housings (e.g., gas insulator switch housings). Nonlinear composite compositions according to the present disclosure may also be useful in surge protectors due to their nonlinear conductivity.

The nonlinear composite compositions of the present disclosure can be used in various articles for various applications, e.g., spray, coating, mastics, tapes, and shaped bodies having a definite configuration. The nonlinear composite compositions of the present disclosure are particularly suitable for use in electrical stress control elements or devices such as high voltage cable accessories, wherein the nonlinear dielectric properties of the compositions are useful.

Electrical stress control devices can be manufactured which are designed with respect to their dielectric properties and their geometric configurations in accordance with desirable modifications of an electric field present at the respective site of application. These stress control devices consist at least partly of the composition of the disclosure. Particularly useful is a dielectric stress control device or element which consists of a shaped body, preferably a sleeve, which can be placed onto an end of a cable insulation and/or shield. Stress control devices or elements having other geometric configurations may be useful to prevent unacceptably high local field concentrations, for example in break elbows, transition or throughgoing connections, feedthroughs and branchings of high tension cables. In certain cable terminations, nonlinear resistive field grading tubes are used in combination with capacitive stress cones.

The nonlinear composite compositions can be provided as (e.g., shaped into) articles of any suitable form. For example, such nonlinear composite compositions may be molded into shaped articles of any form (e.g., flat sheets, tubing or sheathing, plugs, hollow cones). If provided as a pliable layer, or as a grease, wax, gel or mastic, the nonlinear composite composition may be shaped in the field as desired. In some embodiments, such a nonlinear composite composition may be provided as a layer of a multilayer electrical stress control device, with the thickness of a layer being designed as needed. For example, such a layer may be provided as part of a co-extruded annular article. In some embodiments, an article comprising such a nonlinear composite composition may be provided along with one or more ancillary devices, e.g., one or more connectors or terminations for an electric power cable.

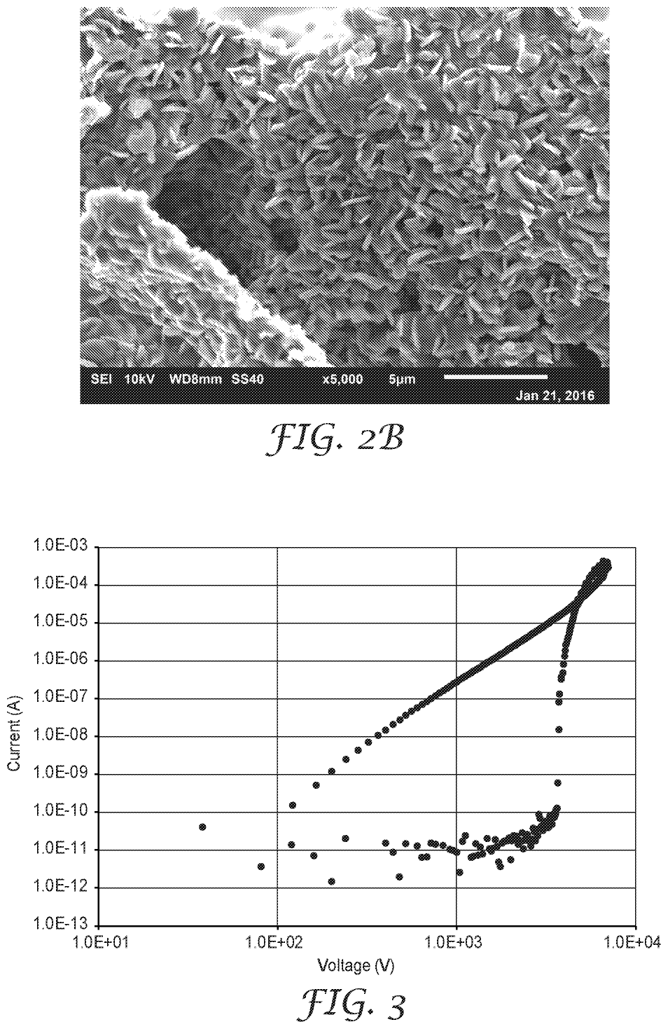

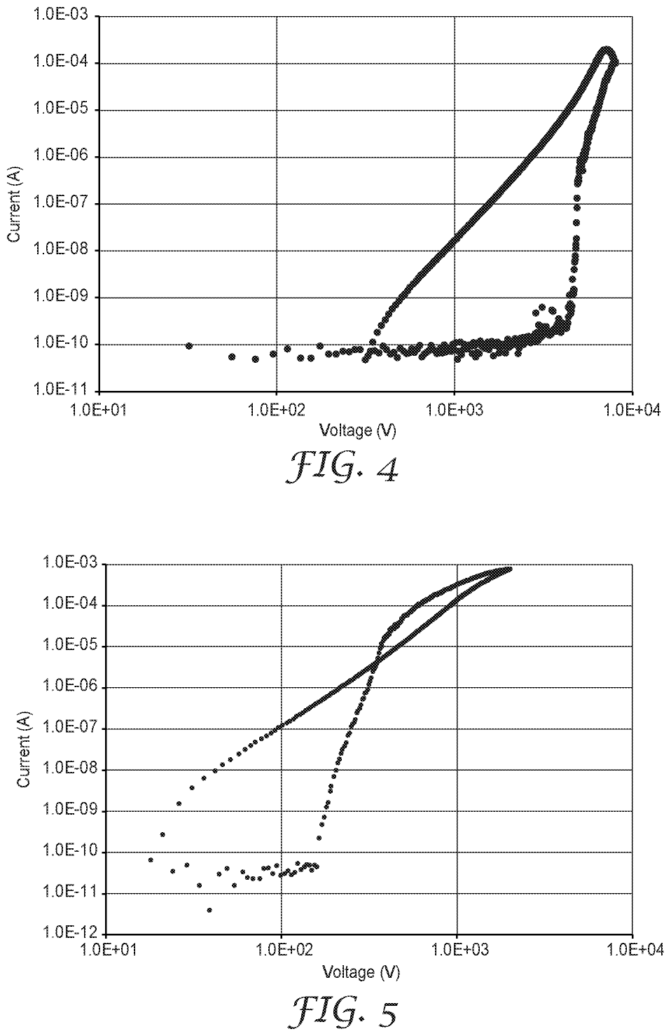

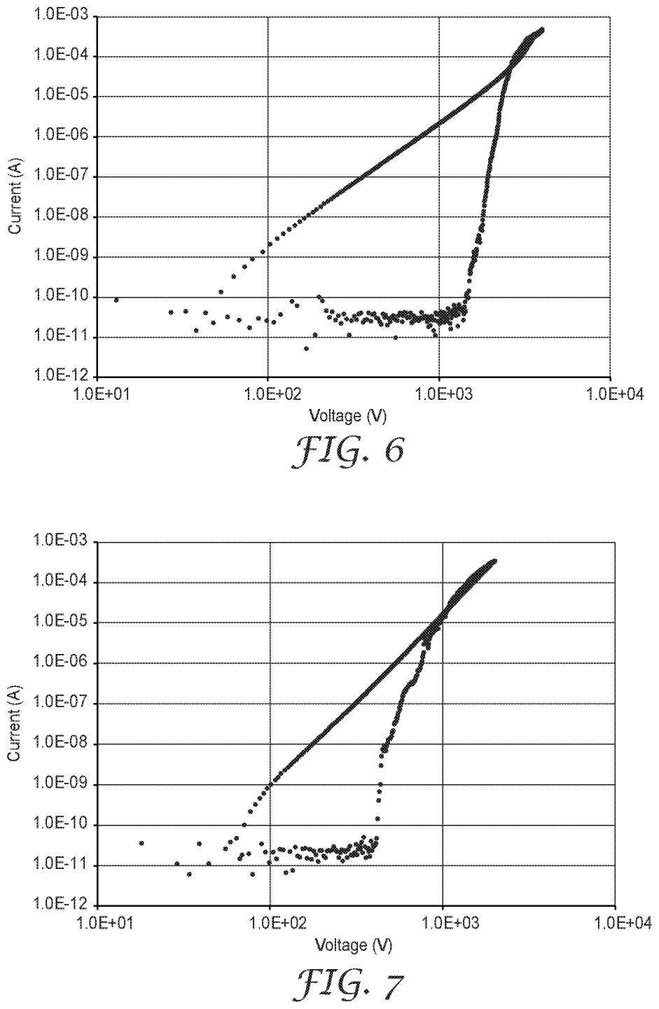

The nonlinear composite compositions disclosed herein may be suitable for use in various electrical stress control applications, because of their ability to provide a reversible non-linear current-voltage relationship. This reversibility is illustrated, for example, in FIGS. 3-7, which show conductivity-electric field curves both as the electric field increases and as it decreases. Nonlinear composite compositions disclosed herein can, if desired, be repeatedly exposed to increasing and decreasing voltages and may exhibit similar (though not necessarily identical) behaviors each time as long as the voltage does not exceed the nonlinear composite composition's irreversible breakdown voltage.

The nonlinear composite compositions disclosed herein may be particularly suitable for use in voltage regulator applications, such as surge arresters, and/or in applications involving electrostatic discharge suppression. And, as mentioned, such nonlinear composite compositions can advantageously mitigate or reduce the effect of electrical stress and may be used, e.g., in terminations and connectors for electrical power cables. In some applications, the herein-disclosed nonlinear composite compositions may serve in combinations of these functions. Advantageously, in any such application, the nonlinear composite compositions may be able to function at higher voltage levels than have been achievable with other materials used in the art.

### Select Embodiments of the Present Disclosure

In a first embodiment, the present disclosure provides a nonlinear composite composition comprising:
a dielectric matrix material; and
flakes of a mixed metal oxide having the formula M1ₓM2_{y}O_{z} dispersed in the dielectric matrix material, wherein:
M1 is selected from the group consisting of alkali metals, alkaline earth metals, and combinations thereof,
M2 is a transition metal or post-transition metal, wherein M2 has an atomic number no greater than 78; and
x is a number in the range 0.3≤x≤1;
y is a number in the range 0.5≤y≤1.5; and
z is a number selected such that the mixed metal oxide is electrically neutral, wherein the amount of flakes in the nonlinear composite composition is sufficient that the nonlinear composite composition has a nonlinear increasing conductance in response to increasing electric field.

In a second embodiment, the present disclosure provides a nonlinear composite composition according to the first embodiment, wherein the flakes have an average aspect ratio of at least 5.

In a third embodiment, the present disclosure provides a nonlinear composite composition according to the first or second embodiment, wherein the mixed metal oxide M1 is an alkali metal.

In a fourth embodiment, the present disclosure provides a nonlinear composite composition according to any one of the first to third embodiments, wherein the mixed metal oxide has the formula M1ₓM2O₂, and wherein the mixed metal oxide is electrically neutral.

In a fifth embodiment, the present disclosure provides a nonlinear composite composition according to any one of the first to fourth embodiments, wherein the ratio of z/y is 2.25.

In a sixth embodiment, the present disclosure provides a nonlinear composite composition according to any one of the first to fifth embodiments, wherein the dielectric nonlinear response is reversible with applied electric field.

In a seventh embodiment, the present disclosure provides a nonlinear composite composition according to any one of the first to sixth embodiments, wherein the mixed metal oxide comprises at least one of Na_{0.72}CoO₂ or Ca₃Co₄O₉.

In an eighth embodiment, the present disclosure provides a nonlinear composite composition according to any one of the first to seventh embodiments, wherein the mixed metal oxide is present in an amount of from 5 to 60 percent by weight, based on the total weight of the nonlinear composite composition.

In a ninth embodiment, the present disclosure provides a nonlinear composite composition according to any one of the first to seventh embodiments, wherein the mixed metal oxide is present in an amount of from 10 to 40 percent by weight, based on the total weight of the nonlinear composite composition.

In a tenth embodiment, the present disclosure provides a nonlinear composite composition according to any one of the first to ninth embodiments, wherein the dielectric matrix comprises a curable resin.

In an eleventh embodiment, the present disclosure provides a nonlinear composite composition according to the tenth embodiment, wherein the curable resin comprises a curable silicone resin.

In a twelfth embodiment, the present disclosure provides a nonlinear composite composition according to any one of the first to ninth embodiments, wherein the dielectric matrix comprises a cured, crosslinked resin.

In a thirteenth embodiment, the present disclosure provides a nonlinear composite composition according to any one of the first to ninth embodiments, wherein the dielectric matrix comprises a polyimide.

In a fourteenth embodiment, the present disclosure provides a nonlinear composite composition according to any one of the first to ninth embodiments, wherein the dielectric matrix comprises a grease.

In a fifteenth embodiment, the present disclosure provides a nonlinear composite composition according to any one of the first to thirteenth embodiments, wherein the dielectric matrix further comprises solvent.

In a sixteenth embodiment, the present disclosure provides a method comprising applying the nonlinear composite composition according to the tenth or eleventh embodiment to a surface of a substrate, and at least partially curing the curable resin.

In a seventeenth embodiment, the present disclosure provides a method comprising applying the nonlinear composite composition according to the fifteenth embodiment to a surface of a substrate, and at least partially removing the solvent.

In an eighteenth embodiment, the present disclosure provides an article comprising a nonlinear composite composition disposed on a surface of a conductive substrate, wherein the nonlinear composite composition comprises:
a dielectric matrix material; and
flakes of a mixed metal oxide having the formula M1ₓM2_{y}O_{z} dispersed in the dielectric matrix material, wherein:
M1 is selected from the group consisting of alkali metals, alkaline earth metals, and combinations thereof;
M2 is a transition metal or post-transition metal, wherein M2 has an atomic number no greater than 78; and
x is a number in the range 0.3≤x≤1;
y is a number in the range 0.5≤y≤1.5; and
z is a number selected such that the mixed metal oxide is electrically neutral, wherein the amount of flakes in the nonlinear composite composition is sufficient that the nonlinear composite composition has a nonlinear increasing conductance in response to increasing electric field.

In a nineteenth embodiment, the present disclosure provides an article according to the eighteenth embodiment, wherein the article comprises a cable termination or splice.

In a twentieth embodiment, the present disclosure provides an article according to the eighteenth embodiment, wherein the substrate comprises a housing, and wherein the surface of the substrate comprises an interior surface of the housing.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Materials used in the Examples were purchased from commercial sources (e.g., Sigma-Aldrich Chemical Co., St. Louis, Mo.) and/or may be obtained by known methods.

Preparation of Flakes of Ca₃Co₄O₉ and NaₓCoO₂

An aqueous solution was prepared at room temperature by mixing appropriate quantities of organic complexing agents and nitrate salts of metal species.

To make Ca₃Co₄O₉ flakes, polyacrylic acid (PAA, M_{w}˜5000 g/mol, 50% in water, Polysciences, Inc., Warrington, Pa.) was mixed with cobalt(II) nitrate hexahydrate (0.21 M, 97.7% min., Alfa Aesar, Ward Hill, Pennsylvania) and calcium nitrate tetrahydrate (0.21 M, ACS, 99.0-103.0%, Sigma-Aldrich Co.) in deionized water (Ca to Co mole ratio was set to 1).

To make NaₓCoO₂ flakes, either PAA or citric acid (CA, citric acid monohydrate, ACS, 99.0-102.0%, Alfa Aesar) was mixed with cobalt(II) nitrate hexahydrate (0.23 M, 97.7% min., from Alfa Aesar) and sodium nitrate (0.165 M, 98+%, Alfa Aesar) in deionized water (Na to Co ratio was set to 0.72). In all cases, the ratio of carboxylate groups to total metal ions was set to 1:2. For NaₓCoO₂ using PAA instead of CA typically led to a more anisotropic final product.

The aqueous solution was stirred and evaporated on a hotplate until it reached 20% of the initial volume. The temperature of the hot plate was adjusted to maximize the evaporation rate without boiling. The resulting dark red solution was then combusted on a hot plate or electric burner. If a hot plate was used, the temperature of the hot plate was set to >500° C. for combustion to take place. The resulting black powder was then calcined in a box furnace for 6 hours at 650° C. The calcined powders were characterized by x-ray diffraction (XRD) analysis and phase matching was consistent with NaₓCoO₂ and Ca₃Co₄O₉ compounds. FIGS. 2A and 2B show Scanning Electron Microscopy (SEM) images of the Ca₃Co₄O₉ flakes produced above.

### Examples 1-5

A silicone polymer matrix was used as the dielectric matrix material for making nonlinear composite compositions.

Mixtures of silicone (SYLGARD 184 SILICONE ELASTOMER BASE, Dow Corning, Midland, Mich.) and curing agent (SYLGARD 184 SILICONE ELASTOMER CURING AGENT, Dow Corning) with NaₓCoO₂ or Ca₃Co₄O₉ mixed metal oxide flake fillers were prepared in the lab. While the silicone base polymer to curing agent weight ratio was kept the same for all Examples (9:1 wt. ratio), the fillers were added at different weight ratios to make nonlinear composite compositions for electrical stress control in high voltage (HV) cables as reported in Table 1.

For each example, a mixture (9:1 wt. ratio) of liquid silicone polymer (SYLGARD 184 SILICONE BASE POLYMER) and liquid curing agent (SYLGARD 184 SILICONE CURING AGENT) was placed into a small plastic container along with an appropriate amount of the selected various mixed metal oxide filler material. A high speed mixer (DAC 150 FVZ, Siemens) was used (at approximately 2000 rpm for about 1 minute) to disperse the filler in the liquid silicone mixture. The resulting mixture was poured into a circular plastic mold and placed in a convection oven set at 150° C. for approximately 1 hour.

The resulting article was then sandwiched between a pair of aluminum plates and the entire stack was placed into a Carver Laboratory Press (Model No. 2699, Wabash, Indiana). The press was used to apply a force of approximately 6 metric tons for thirty minutes (with the sample being held at room temperature). The temperature of the sample was then increased to 100° C. for about four hours. In multiple experiments, aluminum plates (and spacers as needed) of a variety of different thicknesses were used. The resulting articles were flexible solid sheets that ranged from approximately 0.7 mm to 1.6 mm in average thickness. Compositions are reported in Table 1, below.

TABLE 1

| | MIXED METAL OXIDE | | | NONLINEAR |
|---|---|---|---|---|
| | | | Weight Percent | COMPOSITE |
| | | Organic | in Nonlinear | COMPOSITION |
| EXAM- | Targeted | Complexing | composite | THICKNESS, |
| PLE | Compound | Agent | composition | mm |
| 1 | Ca₃Co₄O₉ | PAA | 15 | 1.1 |
| 2 | NaₓCoO₂ | CA | 15 | 1.1 |
| 3 | NaₓCoO₂ | CA | 30 | 0.7 |
| 4 | NaₓCoO₂ | PAA | 15 | 1.6 |
| 5 | NaₓCoO₂ | PAA | 30 | 1.1 |

### High Voltage Current/Voltage Measurement of Composite Samples

The current/voltage (I/V) and conductivity characteristics of the nonlinear composite composition specimens (Examples 1-5) were determined using an automated and safety enclosed apparatus consisting of a Keithley 6485 programmable picoammeter, a Keithley 2290-10 high voltage power supply and a USB-GPIB device which connects the picoammeter and power supply to a computer. The measurement apparatus was capable of applying voltage potential on samples up to 10 kV. The measurements were carried out using a step voltage ramp, where the current was measured at the end of each voltage step. Plots showing current (I) vs. applied voltage (V) for Examples 1-5 specimens are reported in FIGS. 3-7, respectively.

For each of the nonlinear composite composition samples (Examples 1 to 5), electrical conductivity values were significantly higher at high electric-field than at low electric-field. In the measured electric-field ranges the conductivity increase for different samples ranged from 5 to 6 orders of magnitude (see FIGS. 3-7). Accordingly, the nonlinear composite compositions of Examples 1-5 are suitable for electrical stress control through non-linear change in resistance. Interestingly, electrical current for all samples decreased with increasing voltage up to a turning point, threshold voltage, where the non-linear regime started, and after which current started to increase dramatically. The approximate turning point E-field values are reported in Table 2, below.

TABLE 2

| | APPROXIMATE |
|---|---|
| | NONLINEAR REGIME |
| | ONSET |
| | (THRESHOLD |
| | VOLTAGE), |
| EXAMPLE | Volts |
| Example 1 | 3.6 × 10³ |
| Example 2 | 4.3 × 10³ |
| Example 3 | 1.6 × 10² |
| Example 4 | 1.4 × 10³ |
| Example 5 | 4.1 × 10² |

The voltage (V) across a varistor (nonlinear dielectric) material and the current (I) that passes through it are related by the power law:

I=KV^{α}

wherein K is a constant, and a is known as the nonlinear coefficient. At low applied fields the composite compositions demonstrate a linear I-V characteristic (i.e., the current varies linearly with change in voltage). With increasing electric field the current changes rapidly in a nonlinear fashion resulting in current value changes by several orders of magnitude. This, gives a nonlinear coefficient value of a in the range of 10-24. Such moderate values of the nonlinear coefficient are very useful for designing electrical stress control accessories.

The nonlinear composite material has a field dependent conductivity. Thus, the conductivity of the nonlinear composite material, can vary by orders of magnitude with only small changes in applied electrical field, which can be used to our advantage while designing for electrical stress control applications. Accordingly, nonlinear composite compositions of the present disclosure are particularly suitable for use in electrical stress control applications because it has a reversible non-linear conductivity-electrical field characteristics.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1-20. (canceled)

21. A nonlinear composite composition comprising:
a dielectric matrix material; and
flakes of a mixed metal oxide having the formula M1ₓCo_{y}O_{z} dispersed in the dielectric matrix material, wherein:
M1 is selected from the group consisting of alkali metals, alkaline earth metals, and combinations thereof; and
x is a number in the range 0.3≤x≤1;
y is a number in the range 0.5≤y≤1.5; and
z is a number selected such that the mixed metal oxide is electrically neutral, wherein the amount of flakes in the nonlinear composite composition is sufficient that the nonlinear composite composition has a nonlinear increasing conductance in response to increasing electric field.

22. The nonlinear composite composition of claim 21, wherein the flakes have an average aspect ratio of at least 5.

23. The nonlinear composite composition of claim 21, wherein the mixed metal oxide M1 is an alkali metal.

24. The nonlinear composite composition of claim 21, wherein the mixed metal oxide has the formula M1ₓCoO₂, and wherein the mixed metal oxide is electrically neutral.

25. The nonlinear composite composition of claim 21, wherein the ratio of z/y is 2.25.

26. The nonlinear composite composition of claim 21, wherein the dielectric nonlinear response is reversible with applied electric field.

27. The nonlinear composite composition of claim 21, wherein the mixed metal oxide comprises at least one of Na_{0.72}CoO₂ or Ca₃Co₄O₉.

28. The nonlinear composite composition of claim 21, wherein the mixed metal oxide is present in an amount of from 5 to 60 percent by weight, based on the total weight of the nonlinear composite composition.

29. The nonlinear composite composition of claim 21, wherein the mixed metal oxide is present in an amount of from 10 to 40 percent by weight, based on the total weight of the nonlinear composite composition.

30. The nonlinear composite composition of claim 20, wherein the dielectric matrix comprises a curable resin.

31. The nonlinear composite composition of claim 30, wherein the curable resin comprises a curable silicone resin.

32. A method comprising applying the nonlinear composite composition of claim 30 to a surface of a substrate, and at least partially curing the curable resin.

33. The nonlinear composite composition of claim 20, wherein the dielectric matrix comprises a cured, crosslinked resin.

34. The nonlinear composite composition of claim 20, wherein the dielectric matrix comprises a polyimide.

35. The nonlinear composite composition of claim 20, wherein the dielectric matrix comprises a grease.

36. The nonlinear composite composition of claim 20, wherein the dielectric matrix further comprises solvent.

37. A method comprising applying the nonlinear composite composition of claim 36 to a surface of a substrate, and at least partially removing the solvent.

38. An article comprising a nonlinear composite composition disposed on a surface of a conductive substrate, wherein the nonlinear composite composition comprises:
a dielectric matrix material; and
flakes of a mixed metal oxide having the formula M1ₓCo_{y}O_{z} dispersed in the dielectric matrix material, wherein:
M1 is selected from the group consisting of alkali metals, alkaline earth metals, and combinations thereof; and
x is a number in the range 0.3≤x≤1;
y is a number in the range 0.5≤y≤1.5; and
z is a number selected such that the mixed metal oxide is electrically neutral, wherein the amount of flakes in the nonlinear composite composition is sufficient that the nonlinear composite composition has a nonlinear increasing conductance in response to increasing electric field.

39. The article of claim 38, wherein the article comprises a cable termination or splice.

40. The article of claim 38, wherein the substrate comprises a housing, and wherein the surface of the substrate comprises an interior surface of the housing.
